(19) United States
(12) Patent Application Publication
(10) Pub. No.: US 2007/0216286 A1
(43) Pub. Date: Sep. 20, 2007

(54) Image Display Device

(76) Inventor: Tatsuo Tanabe, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/686,995

(22) Filed: Mar. 16, 2007

(30) Foreign Application Priority Data
Mar. 20, 2006 (JP) 2006-076496

(51) Int. Cl. H01J 63/04; H01J 1/62

(52) U.S. Cl. 313/495; 313/496

(57) ABSTRACT

In a planar image display device which includes a plurality of signal lines on a glass substrate and is formed by cutting a wastage from the glass substrate and by simultaneously cutting end portions of the signal lines, at the time of dividing the wastage from the glass substrate, a separation trouble attributed to the presence of the signal lines can be eliminated. In the present invention, the cross-sectional area of a portion to be cut of a video signal line is set smaller than a cross-sectional area of other line portions of the video signal line.

### CLAIM OF PRIORITY

The present application claims priority from Japanese Application JP 2006-076496 filed on Mar. 20, 2006, the content of which is hereby incorporated by reference into this application.

### BACKGROUND OF THE INVENTION

1. Field of the Invention

The present invention relates to a self-luminous flat-panel-type image display device, and more particularly to an image display device which arranges thin-film-type electron sources in a matrix array.

2. Description of the Related Art

As oneself-luminous flat-panel-type image display (FPD) having electron sources which are arranged in a matrix array, a field emission type image display device (FED: Field Emission Display) which uses minute integrative cold cathodes and an electron emission type image display device have been known.

As the cold cathode, there have been known a electron source such as a Spindt-type electron source, a surface-conducive-type electron source, a carbon-nanotube-type electron source, an MIM (Metal-Insulator-Metal) type electron source which is formed by stacking a metal layer, an insulator and a metal layer in this order, an MIS (metal-insulator-semiconductor) type electron source which is formed by stacking a metal layer, an insulator and a semiconductor in this order or a metal-insulator-semiconductor-metal type electron source.

The generally-used self-luminous-type FPD includes a back panel which arranges the above-mentioned electron sources on a back substrate formed of a glass plate, a face panel which arranges phosphor layers and an anode which forms an electric field for allowing electrons emitted from the electron sources to impinge on the phosphor layers on a face substrate formed of a glass plate and a frame body which holds an inner space defined between both facing panels into a predetermined distance, wherein the FPD is configured to hold a display space which is defined by both panels and the frame body into a given vacuum state. The FPD is constituted by combining a drive circuit with the display panel.

Further, on the back substrate of the back panel, a plurality of scanning signal lines which extend in one direction and are arranged in parallel to each other in another direction orthogonal to one direction and to which scanning signals are applied sequentially are arranged and, further, on the back substrate, a plurality of video signal lines which extend in another direction and are arranged in parallel to each other in one direction to intersect the scanning signal lines are arranged. Further, in generally, the electron sources are arranged in the vicinity of respective intersecting portions of the scanning signal lines and the video signal lines, the scanning signal lines and the electron sources are connected to each other by power supply electrodes, and a current is supplied to the electron sources from the scanning signal lines.

The individual electron source forms a pair with the corresponding phosphor layer so as to constitute a unit pixel. Usually, one pixel (color pixel) is constituted of the unit pixels of three colors consisting of red (R), green (G) and blue (B). Here, in the case of the color pixel, the unit pixel is also referred to as a sub pixel.

In addition to the above-mentioned constitution, in the image display device as described above, in the inside of a display region which is defined by the frame body arranged between the back panel and the face panel, a plurality of distance holding members (hereinafter referred to as spacers) are arranged and fixed. The distance between the above-mentioned both panels is held at a predetermined distance in cooperation with the frame body. The spacers are formed of a plate-like body made of an insulating material such as glass, ceramics, or a material having some conductivity in general. Usually, the spacers are arranged at positions which do not impede an operation of pixels for every plurality of pixels.

Further, the frame body which constitutes a sealing frame is fixed to inner peripheries of the back substrate and the face substrate using a sealing material such as frit glass, and the fixing portions are hermetically sealed thus forming sealing regions. The degree of vacuum in the inside of a display region defined by both substrates and the frame body is set to about 10⁻⁵ to 10⁻⁷ Torr, for example.

Scanning signal line lead terminals which are connected to the scanning signal lines formed on the back substrate and video-signal-line lead terminals which are connected to the video signal lines formed on the back substrate respectively penetrate the sealing regions defined between the frame body and both substrates. At least one of the scanning signal line lead terminals and video-signal-line lead terminals which penetrate the sealing regions have distal ends thereof arranged to extend to a position at which the distal ends of the lead terminals substantially agree with a cut end surface of the back substrate.

Patent Document 1: JP-A-2004-224601

Patent Document 2: JP-A-9-45243

Patent Document 3: JP-A-2004-363075

### SUMMARY OF THE INVENTION

With respect to the self-luminous-type image display device as described above, in the same manner as the liquid crystal display device described in patent document 1, there has been known a manufacturing method of the image display device. In this manufacturing method, a large-sized parent glass plate having a size which is capable of acquiring a plurality of actual products is used. After predetermined electrodes and part are respectively arranged on the products, a face parent substrate glass and a back parent substrate glass are adhered to each other by way of a frame body and the adhered parent substrates are cut and are divided into a size of an actual product or into a size substantially equal to a size of the actual product.

Further, also in the patent document 2, a manufacturing method of a vacuum sealing container by multiple production is disclosed.

Further, among manufacturing steps of these manufacturing methods, there have been also known steps in which the large-sized parent glass is firstly separated into glass substrates having a size approximately close a size of an actual product and, thereafter, from the glass substrate on which common electrodes, for example, which are used only in the manufacturing steps and are unnecessary in the actual product are formed, some common electrodes and glass substrate are simultaneously removed.

For example, in the image display device which uses electron-emission-type electron sources, distal ends of respective signal lines are collectively formed as common electrodes in anodization treatment step of electron source insulation films or activation treatment step of electron sources and, thereafter, the common electrode portions are cut and removed together with a back substrate below the common electrode portions thus simultaneously realizing the independence of the respective signal lines and the shaping of the back substrate.

However, when the glass substrate and the metal lines above the glass substrate are simultaneously cut, compared to a case in which only the glass substrate is cut, there arises a drawback that vertical cracks which are necessary for dividing the glass substrate are not generated or such vertical cracks are shallow and hence, the glass substrate cannot be normally separated. Accordingly, there arises a possibility that the mounting of terminal members for external connection becomes difficult.

Further, the adhesiveness of the metal lines with the glass substrate is deteriorated at cut portions of the metal lines thus giving rise to a possibility of the occurrence of leaking.

Further, there exists a possibility that the broken glass pieces are scattered thus damaging the electron sources, for example.

Such conventional constitution has drawbacks such as the insufficient connection with an external circuit, damages on electrodes, leak failures whereby it becomes difficult to ensure an image display quality.

Accordingly, it is an object of the present invention to provide an image display device which can overcome the above-mentioned drawbacks, can realize the accurate separation of a glass substrate and the prevention of scattering of broken glass pieces, can ensure the adhesiveness between metal lines and a glass substrate, and can exhibit an excellent display quality.

To achieve the above-mentioned object, the present invention is characterized in that a cross-sectional area of a cut portion of a metal line is smaller than a metal line cross-sectional area of other portion continuous with the cut portion.

In this manner, the present invention can provide the image display device having an excellent quality by realizing the accurate separation of the glass substrate, the prevention of the scattering of the broken glass pieces and the reliable strong adhesiveness between the metal lines and the glass substrate.

### BRIEF DESCRIPTION OF THE DRAWINGS

FIG. 1A and FIG. 1B are schematic views for explaining a first embodiment of an image display device according to the present invention, wherein FIG. 1A is a plan view as viewed from a face substrate side and FIG. 1B is a side view of FIG. 1A;

FIG. 2 is a schematic plan view taken along a line A-A in FIG. 1B;

FIG. 3 is a schematic cross-sectional view taken along a line B-B in FIG. 2;

FIG. 4 is a schematic cross-sectional view for explaining a manufacturing method of the image display device according to the present invention;

FIG. 5 is a schematic cross-sectional view for explaining the manufacturing method of the image display device according to the present invention;

FIG. 6 is a schematic cross-sectional view taken along a line C-C in FIG. 2 and also is a schematic cross-sectional view of a portion of the face substrate corresponding to the back substrate;

FIG. 7 is a schematic plan view of another embodiment of the image display device according to the present invention corresponding to FIG. 2;

FIG. 8 is a schematic plan view of a portion in FIG. 7 in an enlarged manner;

FIG. 9 is a schematic plan view of still another embodiment of the image display device according to the present invention corresponding to FIG. 2; and

FIG. 10 is a schematic plan view of still further embodiment of the image display device according to the present invention.

### DESCRIPTION OF THE PREFERRED EMBODIMENTS

Hereinafter, the present invention is explained in detail in conjunction with drawings of embodiments.

### Embodiment 1

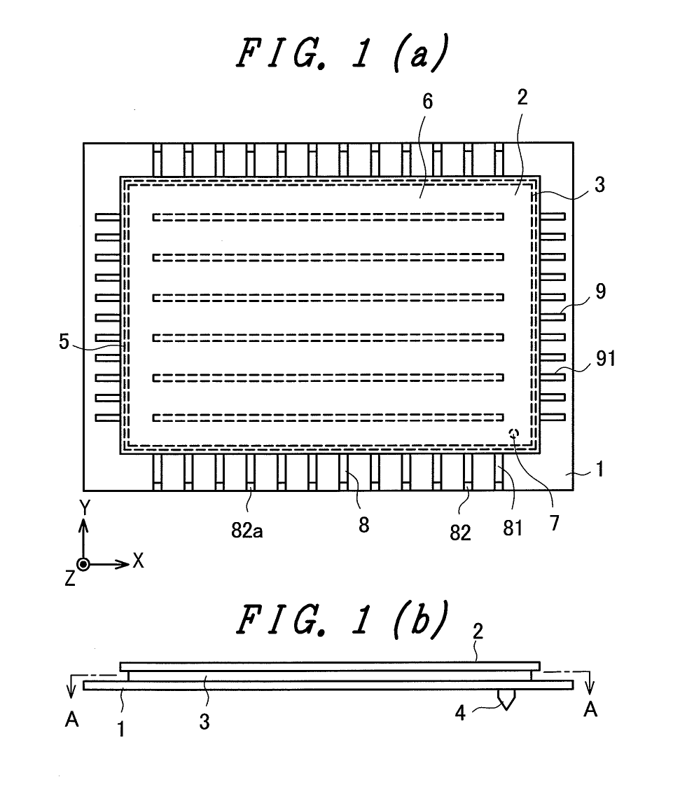

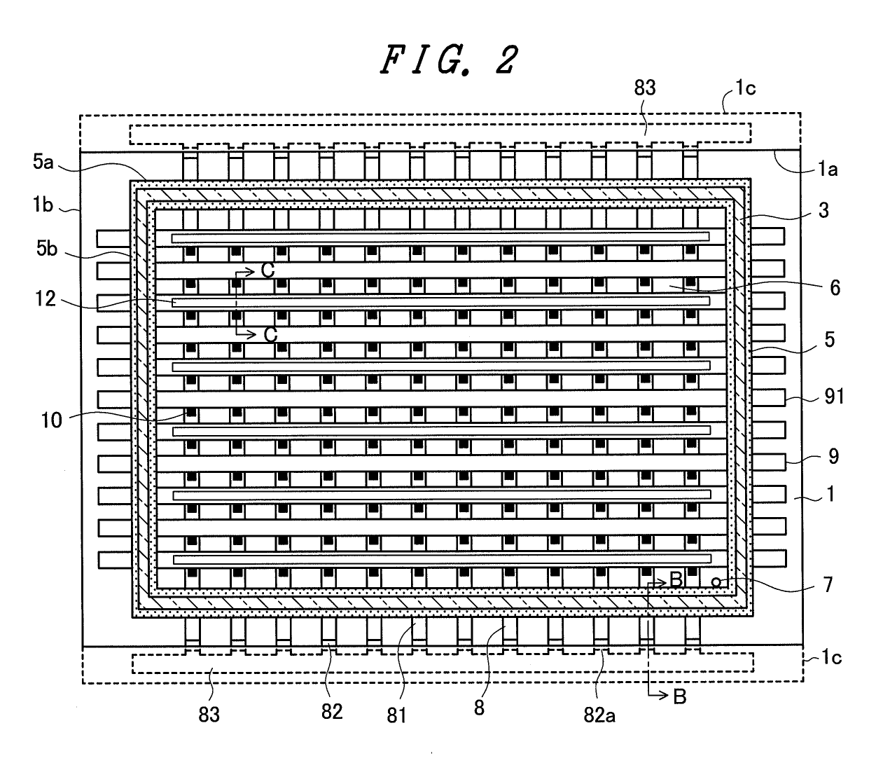

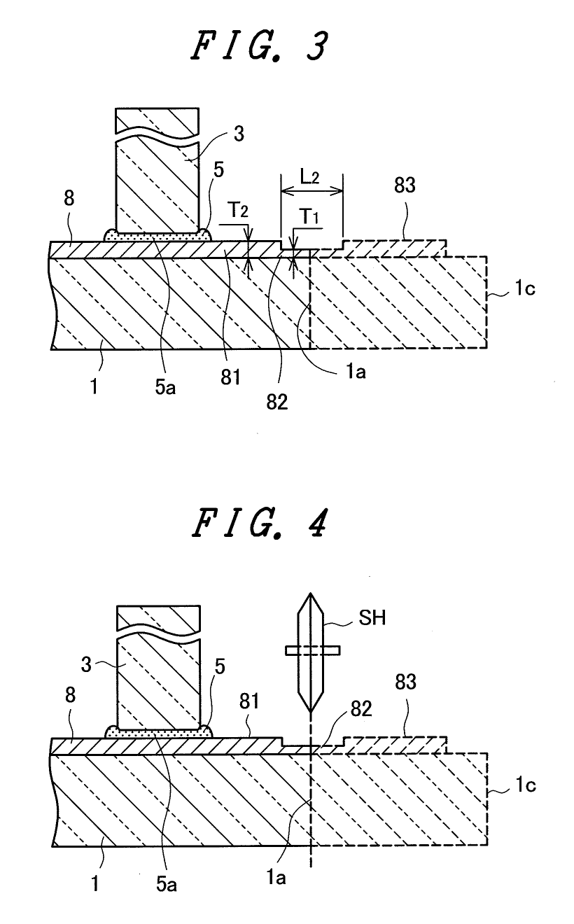

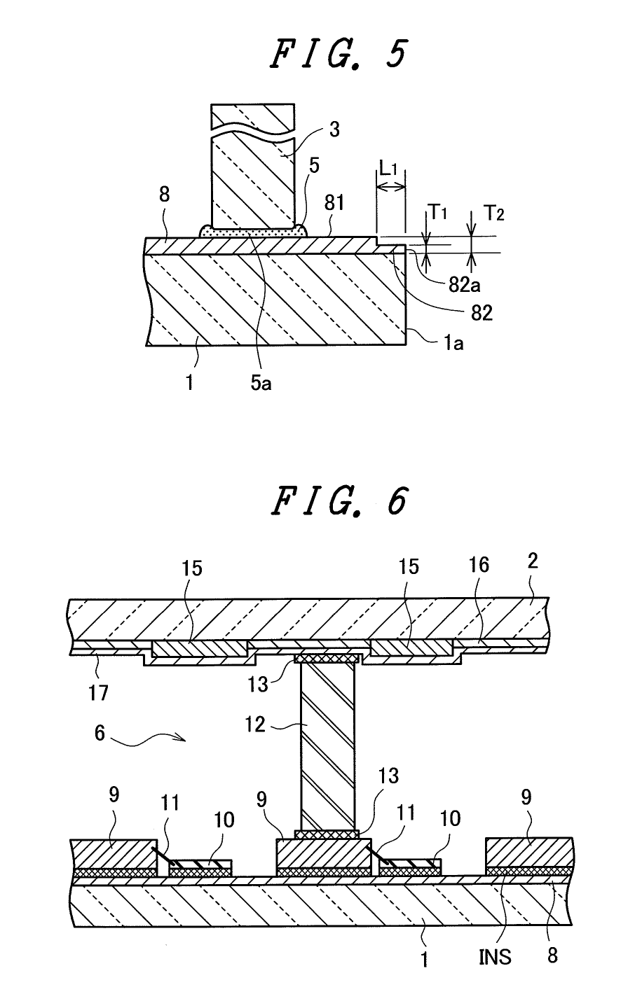

FIG. 1A to FIG. 6 are schematic views for explaining a first embodiment of an image display device according to the present invention, wherein FIG. 1A is a plan view as viewed from a face substrate side and FIG. 1B is a side view of FIG. 1A, FIG. 2 is a schematic plan view taken along a line A-A in FIG. 1B, FIG. 3 is a schematic cross-sectional view taken along a line B-B in FIG. 2, FIG. 4 and FIG. 5 are schematic cross-sectional views for explaining a manufacturing method of the image display device according to the present invention, and FIG. 6 is a cross-sectional view taken along a line C-C in FIG. 2 and a cross-sectional view of a portion of the face substrate which corresponds to the back substrate.

In FIG. 1A to FIG. 6, numeral 1 indicates a back substrate and numeral 2 indicates a face substrate, wherein both substrates 1, 2 are formed of a glass plate having a thickness of several mm, for example, approximately 1 to 10 mm. Both substrates are formed in a substantially rectangular shape. The back substrate and the face substrate are stacked with a predetermined distance therebetween.

Numeral 3 indicates a frame body which exhibits a frame shape. The frame body 3 is made of, for example, a frit glass sintered body, a glass plate or the like. The frame body 3 is formed into a substantially rectangular shape using a single body or a combination of a plurality of members and is interposed between both substrates 1, 2.

Further, the frame body 3 is interposed between peripheral portions of both substrates 1, 2, and both end surfaces of the frame body 3 are hermetically bonded to both substrates 1, 2. A thickness of the frame body 3 is set to a value ranging from several mm to several ten mm, and height of the frame body 3 is set to a value substantially equal to the distance between both substrates 1, 2.

Numeral 4 indicates an exhaust pipe which is fixedly secured to the back substrate 1.

Numeral 5 indicates a sealing material. The sealing material 5 is made of frit glass, for example, and joins the frame body 3 and both substrates 1, 2 thus hermetically sealing the space defined by the frame body 3 and both substrates 1, 2.

A display area 6 which is a space surrounded by the frame body 3, both substrates 1, 2 and the sealing material 5 is evacuated through the exhaust pipe 4 holding a degree of vacuum of, for example, 10⁻⁵ to 10⁻⁷ Torr. Further, the exhaust pipe 4 is mounted on an outer surface of the back substrate 1 as mentioned previously and is communicated with a through hole 7 which is formed in the back substrate 1 in a penetrating manner. After completing the evacuation, the exhaust pipe 4 is sealed.

Numeral 8 indicates video signal lines. The video signal lines 8 are formed of a metal material as described later, and the video signal lines 8 extend in one direction (Y direction) and are arranged in parallel in another direction (X direction) on an inner surface of the back substrate 1. The video signal lines 8 hermetically penetrate a long-side sealing region 5a between the frame body 3 and the back substrate 1 from the display region 6 and extend to a long-side end surface la of the back substrate 1. The video signal lines 8 have distal end portions thereof disposed outside the sealing region 5a thus forming video-signal-line lead terminals 81. The video signal lines 8 further extend from such video-signal-line lead terminals 81 thus forming portions to be cut 82 which have a film thickness T1 and a length L1 on an outer end portion. A film thickness T2 of video-signal-line lead terminals 81 except for the portions to be cut 82 satisfies a following relationship T2>T1. For example, a relationship T1=(0.1 to 0.9) T2 is a practical range, and a relationship T1=(0.2 too 0.5) T2 is a more preferably practical range. Further, terminal end surfaces 82a of the portions to be cut 82 are arranged to become substantially coplanar with the long-side end surface 1a.

The portions to be cut 82, as shown in FIG. 2 to FIG. 4 in detail, further continuously extend outwardly from the terminal end surfaces 82a before separating a wastage 1c indicated by a broken line. Assuming a length of the portions to be cut 82 as L2 with a film thickness T1, the length L2 satisfies a relationship L2>L1. The portions to be cut 82 have distal end portions thereof connected to a common electrode 83 for the video signal lines 8 which are arranged on the wastage 1c. Specifically, as shown in detail in FIG. 5, the terminal end surfaces 82a are arranged coplanar with the long-side end surface 1a when the wastage 1c is separated in later steps. Details of the separation are described later.

Numeral 9 indicates scanning signal lines. The scanning signal lines 9 are formed of a metal material as described later, and the scanning signal lines 9 extend over the video signal lines 8 in the above-mentioned another direction (X direction) which intersects the video signal lines 8 and are arranged in parallel in the above-mentioned one direction (Y direction). The scanning signal lines 9 hermetically penetrate a short-side sealing region 5b formed between the frame body 3 and the back substrate 1 from the display region 6 and extend to the vicinity of a short-side end surface 1b of the back substrate 1. The scanning signal lines 9 have distal end portions thereof disposed outside the sealing region 5b thus forming scanning signal line lead terminals 91.

Numeral 10 indicates MIM-type electron sources which form one kind of electron sources disclosed in patent document 3, for example. The electron sources 10 are formed in the vicinity of respective intersecting portions of the scanning signal lines 9 and the video signal lines 8. Further, the electron sources 10 are connected to the scanning signal lines 9 via connection lines 11. Further, an interlayer insulation film INS is arranged between the video signal lines 8 and the electron sources 10 as well as between the video signal lines 8 and the scanning signal lines 9.

Here, the video signal lines 8 are formed of an Al (aluminum) film, for example, while the scanning signal lines 9 are formed of a Cr/Al/Cr film, a Cr/Cu/Cr film or the like, for example. Further, although the above-mentioned line lead terminals 81, 91 are respectively provided to both ends of the signal lines 8, 9, the line lead terminals 81, 91 may be provided to only either one of these ends.

Next, numeral 12 indicates spacers, wherein the spacers 12 are made of a plate-shaped body which is made of an insulation material such as a glass material, a ceramic material or a member which has some conductivity. In general, the spacers 12 are arranged at positions for every plurality of pixels at which the spacers 12 do not impede operations of pixels.

The spacers 12 possess a resistance value of approximately 10⁸ to 10⁹ Ω·cm and exhibit small non-uniform distribution of the resistance value as a whole.

The spacers 12 are arranged on the scanning signal lines 9 in substantially parallel to the frame body 3 every one line in a vertical manner and are fixed to both substrates 1, 2 using an adhesive member 13 by adhesion.

The fixing of the spacer 12 to the substrates due to the adhesion may be applied to only one end sides of the substrates and, further, the spacers 12 are arranged for every plurality of pixels at positions which do not impede operations of pixels.

Sizes of the spacers 12 are set based on sizes of substrates, a height of the frame body 3, materials of the substrates, an arrangement interval of the spacers, a material of spacers and the like. However, in general, the height of the spacers is approximately equal to a height of the frame body 3. A thickness of the spacer 12 is set to several 10 μm to several mm or less, while a length is set to approximately 20 mm to 1000 mm. Although the length of the spacer 12 may be set more than 1000 mm, preferably, a practical value of the length is approximately 80 mm to 300 mm.

On an inner surface of the face substrate 2 to which one end sides of the spacers 12 are fixed, phosphor layers 15 of red, green and blue are formed in a state that these phosphor layers 15 are arranged in window portions defined by a light-shielding BM (black matrix) film 16. A metal back (anode electrode) 17 made of a metal thin film is configured to cover the phosphor layers 15 and the BM film 16 by a vapor deposition method, for example, thus forming a phosphor screen.

The metal back 17 is a light reflection film for allowing light which is emitted in the direction opposite to the face substrate 2, that is, toward the back substrate 1 side to reflect toward the face substrate 2 side thus enhancing an extraction efficiency of emitted light. The metal back 17 also has a function of preventing surfaces of phosphor particles from being charged.

Further, the metal back 17 is described as a surface electrode. However, the metal back 17 may be formed of stripe electrodes which are divided for respective rows of pixels which intersect the scanning signal lines 9.

Further, with respect to these phosphors, for example, Y₂O₃:Eu, Y₂O₂S:Eu may be used as the red phosphor, ZnS:Cu, Al, Y₂SiO₅:Tb may be used as the green phosphor, and ZnS:Ag, Cl, ZnS:Ag, Al may be used as the blue phosphor. In the phosphor layers 15, particle diameter average of the phosphor particles is set to 4 μm to 9 μm for example, and film thickness thereof is set to about 10 μm to 20 μm for example.

Next, the separation of the back substrate 1 and the wastage 1c is explained.

First of all, on the wastage 1c which is to be separated from the back substrate 1 at a portion of the long-side end surface 1a of the back substrate 1, the common electrode 83 for the video signal lines 8 which is indicated by a broken line is preliminarily arranged.

Before the wastage 1c is separated from the back substrate 1, the common electrode 83 and the video-signal-line lead terminals 81 are connected to each other by way of the thin portions to be cut 82 having the film thickness T1 and the length L2 which constitute the portion of the video-signal-line lead terminals 81.

This connection is configured such that the long-side end surface 1a of the back substrate 1 and substantially center portions of the thin portions to be cut 82 having the film thickness T1 and the length L2 in the length direction agree with each other.

First of all, the back substrate 1 to which a given pre-treatment step is applied using the common electrode 83 which is formed on the wastage 1c, and the face substrate 2 and the frame body 3 having the predetermined constitutions are sealed thus forming a panel assembling body.

After forming the panel assembling body, as shown in one example in FIG. 4, a scribe wheel SH is positioned and is set at a portion which corresponds to the substantially center in the length direction of the thin portions to be cut 82 of the back substrate 1 and above a portion of the long-side end surface la which indicates a cutting line.

Sequentially, the scribe wheel SH is rotated while being in contact with the surface of the back substrate 1 thus cutting the thin portions to be cut 82 of the video-signal-line lead terminals 81 and generating a crack in the portion of the long-side end surface la which becomes the cutting line below the thin portions to be cut 82.

Thereafter, the progress of the generated crack in the downward direction is enhanced thus separating and removing the wastage 1c.

A shape of the back substrate 1 after performing the separation is shown in FIG. 5.

According to this embodiment, the line film thickness T1 of the portions to be cut 82 of the video-signal-line lead terminals 81 is set smaller than the line film thickness T2 of the other portions continuous with the video-signal-line lead terminals 81. Accordingly, a height of a stepped portion between the glass surface and the lines can be decreased and hence, it is possible to suppress a phenomenon that the scribe wheel skips at the stepped portion. As a result, it is possible to uniformly acquire the desired crack realizing the acquisition of a high-dimensional-accuracy substrate with the separated portion having an excellent end shape. Further, scattering of the glass fragments can be eliminated, the generation of peeling-off of the lines from the glass surface can be suppressed and hence, it is possible to acquire an image display device possessing an excellent display quality.

### Embodiment 2

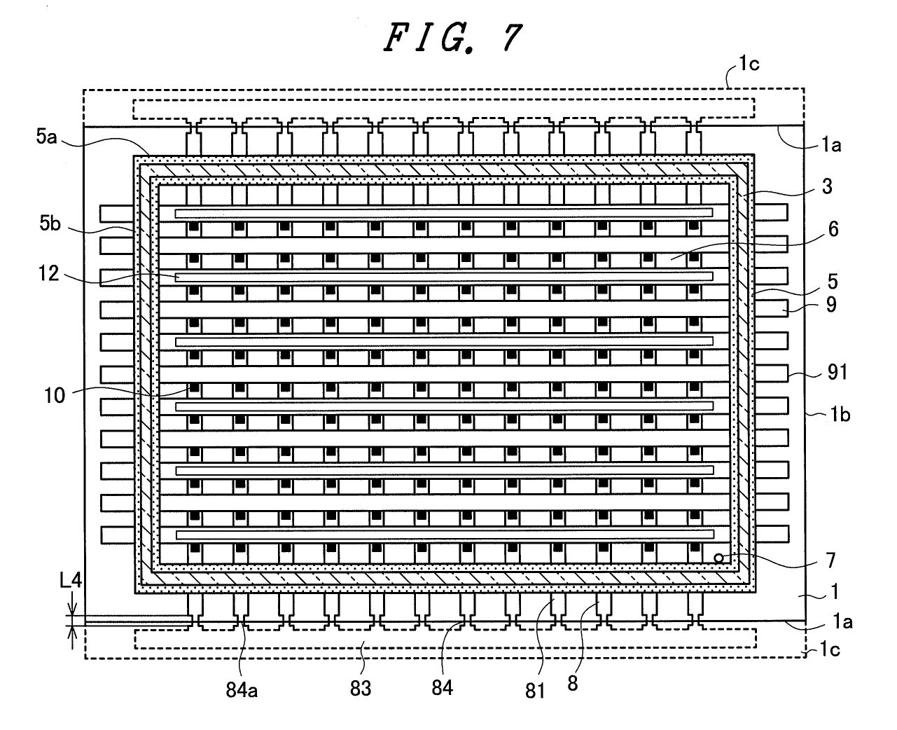

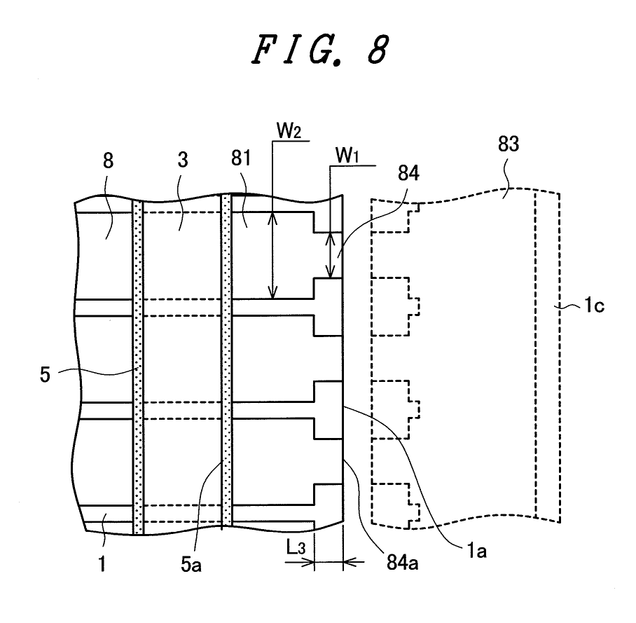

FIG. 7 and FIG. 8 are schematic plan views of another embodiment of the image display device according to the present invention, wherein FIG. 7 is a plan view corresponding to FIG. 2 and FIG. 8 is a plan view of a portion in FIG. 7 shown in an enlarged manner. In FIG. 7 and FIG. 8, parts identical with the parts shown in the above-mentioned drawings are indicated by the same symbols.

In FIG. 7 and FIG. 8, the video signal lines 8 are formed of the above-mentioned metal material and extend in one direction (Y direction) and are arranged in parallel in another direction (X direction) on an inner surface of the back substrate 1. The video signal lines 8 hermetically penetrate a long-side sealing region 5a between the frame body 3 and the back substrate 1 from the display region 6 and extend to a long-side end surface 1a of the back substrate 1. The video signal lines 8 have distal end portions thereof disposed outside the sealing region 5a thus forming the video-signal-line lead terminals 81. The video signal lines 8 further extend from such video-signal-line lead terminals 81 thus forming portions to be cut 84 having a film width W1 and a length L3 on the outside distal end portions thereof. A film width W2 of video-signal-line lead terminals 81 except for the portions to be cut 84 satisfies a following relationship W2>W1. For example, a relationship W1=(0.1 to 0.9) W2 is a practical range, and a relationship W1=(0.2 to 0.5) W2 is a more preferably configuration. Further, terminal end surfaces 84a of the portions to be cut 84 are arranged to become substantially coplanar with the long-side end surface 1a.

The portions to be cut 84 further continuously extend outwardly from the terminal end surfaces 84a before separating the wastage 1c indicated by a broken line. Assuming a length of the portions to be cut 84 as L4 with a film width W1, the length L4 satisfies a relationship L4>L3. The portions to be cut 84 have distal end portions thereof connected to the common electrode 83 for the video signal lines 8 which is arranged on the wastage 1c. The terminal end surfaces 84a are arranged to become substantially coplanar with the long-side end surface 1a when the wastage 1c is separated in later steps.

The other constitutions of this embodiment are equal to the constitutions of the embodiment 1.

According to the embodiment 2, the line film width W1 of the portions to be cut 84 of the video-signal-line lead terminals 81 is smaller than a line film width W2 of the other portions continuous with the video-signal-line lead terminals 81 and hence, it is possible to reduce a distance that the scribe wheel passes on the lines. As a result, it is possible to acquire the desired cracks thus realizing a high-dimensional-accuracy substrate having the separation portion with an excellent end surface shape. Further, scattering of the glass fragments can be eliminated and the generation of peeling-off of the lines from the glass surface can be suppressed and hence, it is possible to acquire an image display device having an excellent display quality.

Further, it may be possible to add the technical concept of the embodiment 1 on the film thickness to the embodiment.

### Embodiment 3

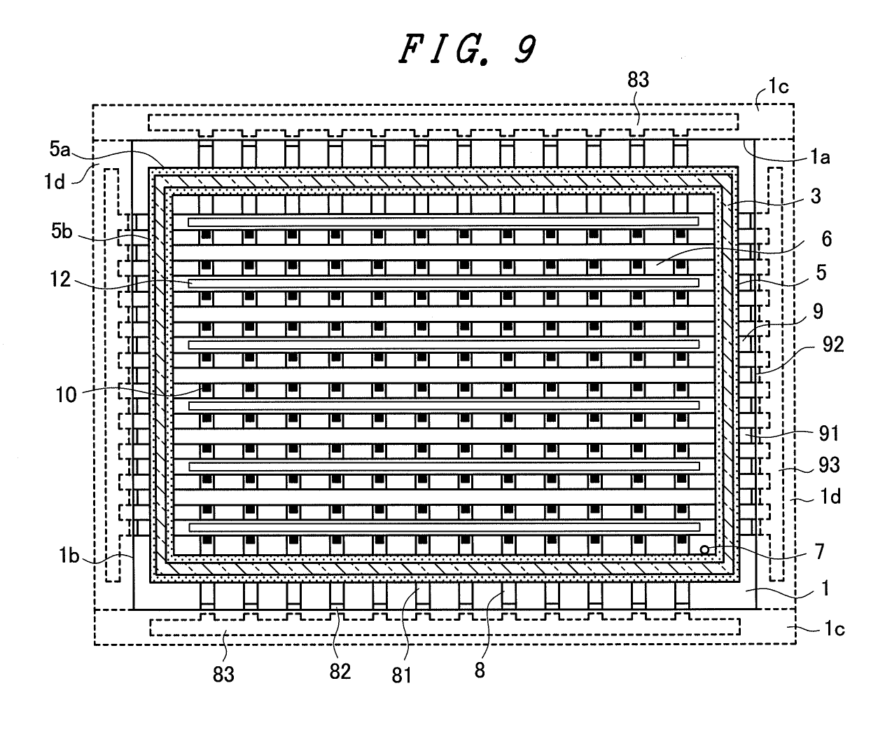

FIG. 9 is a schematic plan view of still another embodiment of the image display device according to the present invention corresponding to FIG. 2, wherein parts identical with the parts shown in the above-mentioned drawings are indicated by the same symbols.

In FIG. 9, in the embodiment 3, in addition to the video-signal-line lead terminals 81 side, thin portions to be cut 92 are also arranged on the scanning-signal-line lead terminals 91 side, and a wastage id is also separated.

Also in the embodiment 3, a film thickness of the portions to be cut 92 of the scanning signal line lead terminals 91 is set smaller than a line film thickness of the other portions which are continuous with the scanning signal line lead terminals 91.

According to the embodiment 3, it is possible to acquire an excellent image display device in the same manner as the embodiment 1 described above.

### Embodiment 4

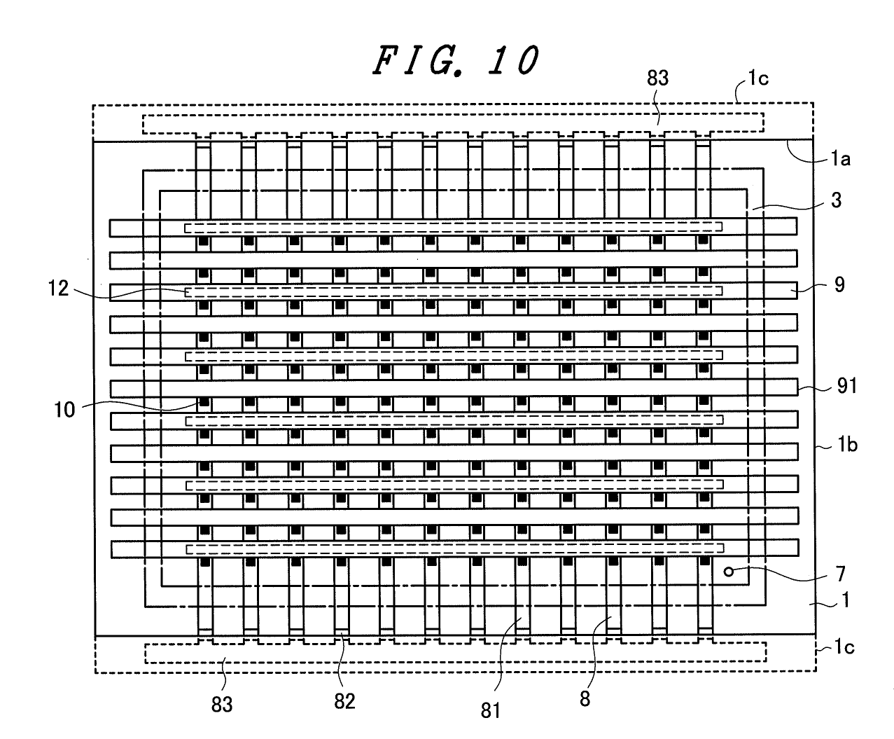

FIG. 10 is a schematic plan view of a back substance of further another embodiment of the image display device according to the present invention, wherein parts identical with the parts shown in the above-mentioned drawings are indicated by the same symbols.

In FIG. 10, the constitution which makes the embodiment 4 differ from the above-mentioned embodiments lies in that the back substrate 1 is separated independently before performing the step for constituting a panel assembly body by sealing the back substrate 1 to the face substrate 2.

In FIG. 10, the video signal lines 8, the scanning signal lines 9 and the respective lead terminals 81, 91 are formed on the glass substrate and, then, electrodes such as the electron sources 10 and the lines are formed on the glass substrate. Thereafter, an anodic treatment is applied to an insulation thin film at portions where the electron sources 10 are arranged using a common electrode 83.

After the anodic treatment is finished, the wastage 1c is separated and removed. Other steps are substantially equal to steps of the embodiment 1. Further, in FIG. 10, the frame body 3, the spacers 12 and the like are indicated by a dotted line at positions where the frame body 3, the spacers 12 and the like are respectively arranged later.

According to the embodiment 4, in addition to the characteristics of the above-mentioned embodiments, the back substrate is separated independently before both substrates are sealed to each other and hence, the present invention can acquire the further advantageous effect that a manufacturing cost of the image display device can be lowered thus leading to the acquisition of a high-quality image display device.

In the embodiments described heretofore, the explanation has been made by taking the structure which uses the MIM-type electron sources as an example. However, the present invention is not limited to the above-mentioned embodiments, and the present invention is also applicable to a self-luminous FPD which uses the various kinds of electron sources in the same manner as the above-mentioned embodiments.

What is claimed is:

1. An image display device comprising:
a back substrate which includes a plurality of scanning signal lines which extend in one direction and are arranged in parallel in another direction orthogonal to one direction, a plurality of video signal lines which extend in another direction and are arranged in parallel in one direction so as to intersect the scanning signal lines, an interlayer insulation film which is arranged between the video signal lines and the scanning signal lines, and electron sources which are formed in the vicinities of respective intersecting portions of the scanning signal lines and the video signal lines,
a face substrate which includes phosphor layers which are provided corresponding to the electron sources, and an acceleration electrode which accelerates electrons emitted from the electron sources so as to direct the electrons to the phosphor layers, the face substrate facing the back substrate with a predetermined distance therebetween;
a frame body which is interposed between the back substrate and the face substrate in a state that the frame body surrounds a display region and holds the given distance; and
a sealing material which hermetically seals the frame body and the face substrate and the back substrate respectively at a sealing region, wherein
at least one ends of the scanning signal lines have scanning signal line lead terminals which extend to the outside of the display region from the display region through a sealing region at which the back substrate and the frame body face each other in an opposed manner,
at least one ends of the video signal lines have video-signal-line lead terminals which extend to the outside of the display region from the display region through a sealing region at which the back substrate and the frame body face each other in an opposed manner, and
at least one of the scanning signal line lead terminals and the video-signal-line lead terminals is configured such that a line cross-sectional area of a distal end portion of the lead terminal perpendicular to the extending direction is smaller than a line cross-sectional area of another portion continuous with the distal end portion perpendicular to the extending direction.

2. An image display device according to claim 1, wherein a line film thickness of the distal end portion of the lead terminal is smaller than a line film thickness of another portion continuous with the distal end portion.

3. An image display device according to claim 2, wherein a line film thickness of the distal end portion of the lead terminal is 0.1 to 0.9 of a line film thickness of another portion continuous with the distal end portion.

4. An image display device according to claim 2, wherein a line film thickness of the distal end portion of the lead terminal is 0.2 to 0.5 of a line film thickness of another portion continuous with the distal end portion.

5. An image display device according to claim 1, wherein a line film width of the distal end portion of the lead terminal is smaller than a line film width of another portion continuous with the distal end portion.

6. An image display device according to claim 5, wherein a line film width of the distal end portion of the lead terminal is 0.1 to 0.9 of a line film width of another portion continuous with the distal end portion.

7. An image display device according to claim 5, wherein a line film width of the distal end portion of the lead terminal is 0.2 to 0.5 of a line film width of another portion continuous with the distal end portion.
